(19) United States
(12) Patent Application Publication
(10) Pub. No.: US 2014/0195683 A1
(43) Pub. Date: Jul. 10, 2014

(54) PREDICTING RESOURCE PROVISIONING TIMES IN A COMPUTING ENVIRONMENT

(71) Applicant: INTERNATIONAL BUSINESS MACHINES CORPORATION, Armonk, NY (US)

(72) Inventors: Raymond Perry Ammerman, III, Durham, NC (US); Paul Basil French, Cork (IE); Paul Fredric Klein, Agoura Hills, CA (US)

(73) Assignee: INTERNATIONAL BUSINESS MACHINES CORPORATION, ARMONK, NY (US)

(21) Appl. No.: 13/734,598

(22) Filed: Jan. 4, 2013

(51) Int. Cl. H04L 12/24

(52) U.S. Cl. CPC H04L 41/00
USPC 709/226

(57) ABSTRACT

Provided are a computer program product, system, and method for provisioning resources of a computing environment using predictive time analysis. In certain computing environments, such as a highly utilized cloud computing environment, a predictive provisioning analysis engine can determine how long a resource provisioning request can take to complete. By learning from a window of previously completed provisioning requests that is kept current, the predictive provisioning analysis engine can accurately predict when the resource provisioning request can complete.

### 1. FIELD OF THE INVENTION

The present invention relates to a computer program product, system, and method for provisioning resources of a highly utilized computing environment.

### 2. DESCRIPTION OF THE RELATED ART

Resource provisioning in a computing environment, such as a cloud computing environment, includes operations to provision resources, such as network devices, storage devices, and virtual machines. These operations can spawn tasks and numerous sub-tasks to eventually provision all the resource dependencies that are a part of the original resource provisioning request. For example, a network provisioning request can spawn a task to provision a Layer 3 resource (e.g. Virtual Routing and Forwarding), a task to provision a Layer 2 resource (e.g. Virtual LAN (VLANs)), a task to provision for IP subnets, and a task to establish firewall zones and policies. In another example of a provisioning request, Virtual Machine (VM) provisioning tasks may include determining available hostnames, determining available platforms, provisioning virtual machines with hypervisors, assigning VMs to an appropriate network resource such a VLAN, and finally notifying a user of completion of the original resource provisioning task. Moreover, in a complex resource provisioning request, spawned tasks can include provisioning multiple virtual machines, related network resources, and storage devices.

Generally, it is difficult to determine a time to complete these resource provisioning requests because of a number of factors, such as the virtualized and dynamic nature of computing environments, availability and capacity of resources, and time of day when capacity and processing power can be overtaxed with current outstanding provisioning requests. There is a need in the art for improved techniques for deterministic resource provisioning in computing environments.

### SUMMARY

Provided are a computer program product, system, and method for predicting resource provisioning times in a computing environment. For example, with respect to a computer program product for resource provisioning in a computing environment, the computer program product includes a computer readable storage medium having computer readable program code embodied therein that executes to perform operations. These operations include receiving a provisioning request for resources of the computing environment and executing the provisioning request for resources. The resources can be identified as having at least one of a firm requirement and a soft requirement. The operations also include adding a provisioning request result to a repository, such that the repository includes information for predicting a provisioning time to complete a future provisioning request and determining at least one of a time to provision value and a time to failure value to complete the future provisioning request.

In an example of a system for resource provisioning in a computing environment, the system includes a processor of a computing device of the computing environment. The system also includes a computer readable storage medium having computer readable program code embodied executed by the processor to perform operations. These operations further include receiving a provisioning request for resources of the computing environment and executing the provisioning request for resources. The resources can be identified as having at least one of a firm requirement and a soft requirement. The operations also include adding a provisioning request result to a repository, such that the repository includes information for predicting a provisioning time to complete a future provisioning request. The system can also determine at least one of a time to provision value and a time to failure value to complete the future provisioning request.

With respect to a method for resource provisioning in a computing environment, the method includes receiving a provisioning request for resources of the computing environment and executing the provisioning request for resources. The resources can be identified as having at least one of a firm requirement and a soft requirement. Moreover, the method includes adding a provisioning request result to a repository, such that the repository includes information for predicting a provisioning time to complete a future provisioning request. The method also includes the ability to determine at least one of a time to provision value and a time to failure value to complete the future provisioning request.

### BRIEF DESCRIPTION OF THE DRAWINGS

FIG. 1 illustrates an example of a computing environment in which embodiments are implemented;

FIG. 2A illustrates an embodiment of a prediction system of the computing environment;

FIG. 2B illustrates an embodiment of a graph of a window in operation;

FIG. 3 illustrates an embodiment of a provisioning request and associated information for use by the prediction system;

FIG. 4 illustrates an embodiment of a snapshot in time of predicting resource provisioning times in the computing environment;

FIG. 5 illustrates an embodiment of operations for collecting a history of resource provisioning behavior; and

FIG. 6 illustrates an embodiment of operations for predicting resource provisioning times in a computing environment.

### DETAILED DESCRIPTION

Described embodiments provide techniques for predicting resource provisioning times in a computing environment. For example, in a highly utilized cloud computing environment, users of cloud services access a virtualized computing infrastructure including network devices, computing device platforms (systems, servers, clients, and the like), virtual machines, and storage devices. When requesting access to applications, middleware, or devices of the computing environment, resources are provisioned and provided to the requestor for use. Since it is difficult to predict when the resource provisioning times will complete, embodiments of the present invention predict the time to complete a resource provisioning request or a time to failure, to enable the requestor to take appropriate action.

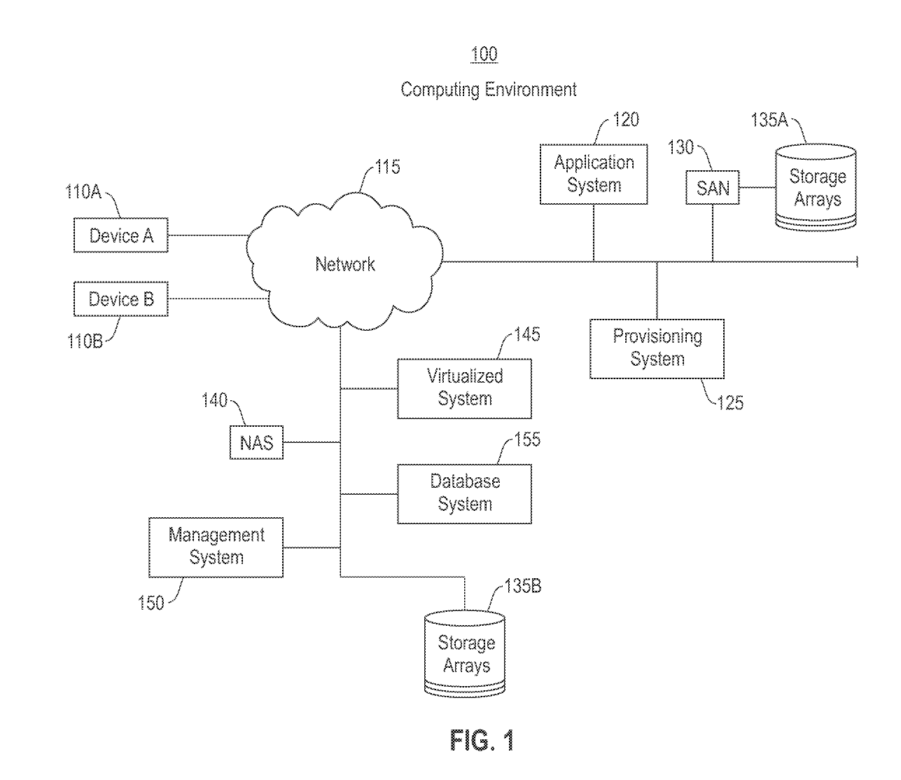

FIG. 1 illustrates an example of a computing environment 100 in which embodiments are implemented. The computing environment 100 include various examples of computing device platforms, such as computer servers, clients, mainframes, laptops, mobile devices, software applications, middleware, network devices, and storage systems. These computing device platforms are connected by physical media or wireless technology to enable communication among a network 115, which can be a local area network (LAN), wide area network (WAN), cloud computing model, etc. or any combination thereof. It should be appreciated that in the example of FIG. 1, a device-A 110A and device-B 110B can be any type of computing device platform, such as a laptop or mobile device (e.g. handheld, wearable, or the like).

Users may interact directly with the device-A 110A and device-B 110B to initiate resource provisioning requests to other computing device platforms of the computing environment 100. In an alternative embodiment, an application system 120, which can be a computer operating as an email server, host application server, or the like, can also communicate resource provisioning requests on the network 115. Computing device platforms can also communicate resource provisioning requests via a direct cable connection to other platforms or may comprise components on a single computer, and may communicate over a bus or via memory of the single computer.

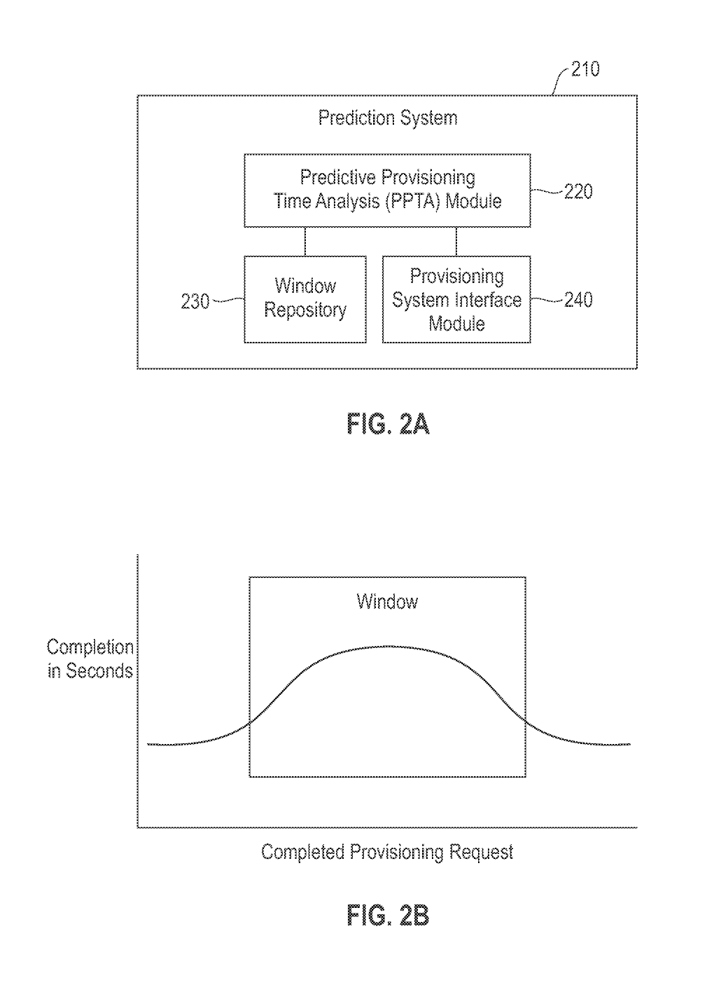

The computing environment 100 also includes a provisioning system 125 which satisfies resource provisioning requests. Although the provisioning system 125 can implement embodiments of the present invention, in other embodiments, other devices or software modules of the computing environment can predict resource provisioning times, as described further below with respect to FIG. 2. For example, in an alternative embodiment, some portion, or all of the invention may be implemented in a hardware component, such as a dedicated integrated circuit, e.g., Application Specific Integrated Circuit (ASIC), expansion card, etc. of a single computer.

The computing environment 100 also includes storage systems, such as storage area network (SAN) 130 and network attached storage (NAS) 140. Each storage system can communicate with storage arrays 135A or storage arrays 135B. These storage systems are known in the art and storage media of the storage arrays can be implemented in one or more storage devices, such as interconnected hard disk drives (e.g., configured as a DASD, RAID, JBOD, etc.), solid state storage devices (e.g., EEPROM (Electrically Erasable Programmable Read-Only Memory), flash memory, flash disk, storage-class memory (SCM)), electronic memory, magnetic tape media, tape cartridges, etc.

In addition to storage systems, the computing environment can include a virtualized system 145, which may implement a hypervisor to enable a virtual machine (VM), a database system 155, such as DB2®, and a management system 150, which can monitor and/or control some or all of the devices and applications of the computing environment 100. Although not an exhaustive list, these computing device platforms can be personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and the like.

Software modules of the computing device platforms may be described in the general context of a computer system executing instructions of program modules. Generally, program modules may include routines, programs, objects, components, logic, data structures, and so on that perform particular tasks or implement particular abstract data types. Further, the components of the computer system may include, but are not limited to, one or more processors or processing units, a system memory, and a bus that couples various system components including system memory to a processor. These computer system hardware components are not shown, but are well known to those of ordinary skill in the art. For example, the bus can represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer system can also include a variety of computer system readable media. Such media may be any available media that is accessible by the computer system, and it includes both volatile and non-volatile media, removable and non-removable media, and may be used for storing the data, object information, and the like.

The computer system memory can include computer system readable media in the form of volatile memory, such as random access memory (RAM) and/or cache memory. The computer system may further include other removable/non-removable, volatile/non-volatile computer system storage media. By way of example only, NAS 140 can be provided for reading from and writing to a non-removable, non-volatile magnetic media (not shown and typically called a “hard drive”) of storage arrays 135B. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to a bus by one or more data media interfaces. As will be further depicted and described below, in one embodiment, the computer systems memory, such as of the provisioning system 125, may include at least one program product having a set (e.g., at least one) of program modules that are configured to carry out the functions of embodiments of the invention.

Moreover, a program module may be stored in memory, by way of example, and not limitation, as well as an operating system, one or more application programs, other program modules, and data. Each of the operating system, one or more application programs, other program modules, and data or some combination thereof, may include an implementation of a networking environment. Program modules generally carry out the functions and/or methodologies of embodiments of the invention as described herein, such as the operations for predicting resource provisioning times.

Any computing device platform of the computing environment 100 may also communicate with one or more external devices (not shown) such as a keyboard, a pointing device, a display, etc. Such communication can occur via Input/Output (I/O) interfaces (not shown). Still yet, the computing platform device can communicate with one or more networks outside of network 115, such as other local area networks (LANs), general wide area networks (WANs), and/or a public network (e.g., the Internet) via network devices. It should be understood that although not shown because these components are well known to those of ordinary skill in the art, other hardware and/or software components could be used in conjunction with the computing device platform. Examples, include, but are not limited to: microcode, device drivers, redundant processing units, external disk drive arrays, RAID systems, tape drives, and data archival storage systems, etc.

FIG. 2A illustrates an embodiment of a prediction system 210 of the computing environment 100. The prediction system 210 includes modules to predict resource provisioning times as contemplated by the invention herein. It should be appreciated that the modules can be implemented as hardware-only, software-only, or combination (hardware/software) modules. Specifically, an embodiment of the prediction system 210 can be incorporated in the provisioning system 125 as software modules. In yet another embodiment, the management system 150 can implement the invention as a hardware module. Accordingly, one of ordinary skill can appreciate that any computing device platform of the computing environment 100 can also operate the prediction system 210 as a combination hardware/software module.

Specifically, the prediction system 210 includes a predictive provisioning analysis (PPTA) module 220, a window repository 230, and a provisioning system interface module 240. The PPTA module 220 includes methods for analyzing different status information related to a resource Provisioning Request (PR), such as the time to PR completion or failure to complete. Specifically, the PPTA module 220 is used to predict the length of time a PR will take to complete. To perform this function, the PPTA module 220 is aware of the period of time, or time to provision (TTP) value for a successful PR. Further, the PPTA module 220 is aware of a time to failure (TTF) value for a PR that fails to complete.

The PPTA module 220 dynamically learns on-the-fly about the computing environment 100 by tracking TTP and TTF for any given provisioning request. Accordingly, short terms changes in TTP and TTF define a window of completed provisioning requests, or alternatively, windowed provisioning requests (WPRs). Specifically, each window reflects the most recent provisioning activity along with completed provisioning requests. The PPTA module 220 interfaces with the window repository 230 to enable easy access to stored windows and is thus a memory for the PPTA module 220. The window repository 230 is a configurable size and can be implemented as a database. Moreover, the database can be of any type, such as a relational database, flat file, tree structure, or the like. As each provisioning request completes or fails to complete, the window repository 230 records this information for use by the PPTA module 220 for new provisioning requests. In one embodiment, the window repository 230 can operate as a queue using a first-in-first-out (FIFO) strategy. It should be appreciated that any abstract data type can be used to implement the window repository 230, as long as the PPTA module 220 can use the window repository 230 to continually learn about the success and failure of provisioning requests.

The PPTA module 220 also interfaces with the provisioning system interface module 240. In one contemplated embodiment, the provisioning system interface module 240 is an application programming interface (API) to an IBM Tivoli® Service Automation Manager (TSAM), or the like. Specifically, IBM TSAM and similar products, can be embodied by a provisioning system 125 to perform automated provisioning, management, and de-provisioning of computing device platforms of a computing environment 100. As previously described with respect to FIG. 1, the computing environment includes servers, networks, operating systems, middleware, application software, virtualization environments (hypervisors) and storage systems. Volumes, processes, server processing time, and the servers, etc. above, are all examples of resources that are known by the provisioning system 125. When a new PR enters the prediction system 210, the PPTA module 220 predicts the time for the new PR to complete by reviewing the windows stored in the window repository 230. Concurrently, the PPTA module 220 also may receive the completion time or failure of a prior PR via the provisioning system interface module 240, which receives that information from the provisioning system 125. The success or failure information provided by the provisioning system 125 via the provisioning system interface module 240 is also recorded with the corresponding prior PR in the window repository 230.

FIG. 2B illustrates an embodiment of a graph of a window in operation. Specifically, along the continuum of time during the operation of the prediction system 210, the window continues to reflect completed provisioning requests or WPRs. As time progresses along the continuum, some provisioning requests may take a few seconds (or less) to complete or may take many more seconds to complete. By keeping a history in the window of the completion behavior (whether success or failure) of provisioning requests, the prediction system 210 can accurately predict whether a new provisioning request will complete in a particular time period.

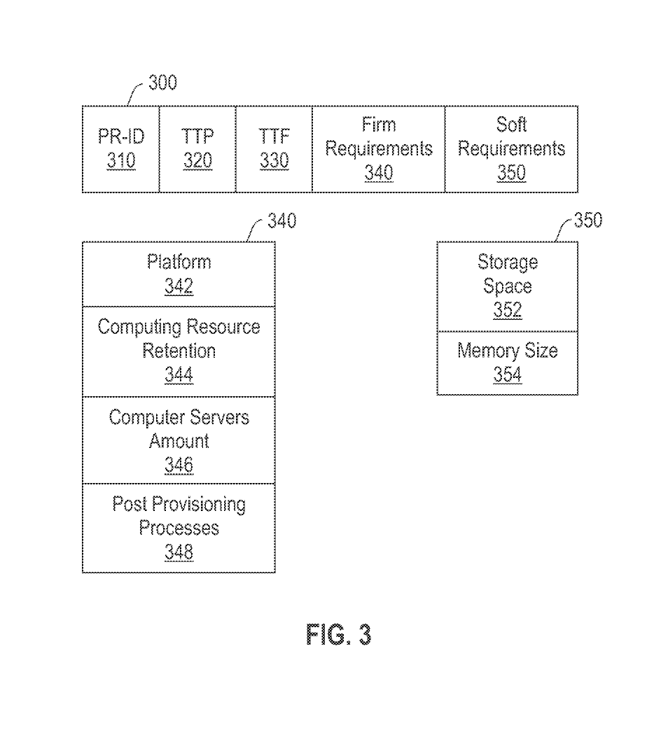

FIG. 3 illustrates an embodiment of a provisioning request and associated information for use by the prediction system 210. For example, a window 300 can include a provisioning identifier (PR-ID) 310, TTP 320, TTF 330, firm requirements 340 and soft requirements 350. The associated information may be included in one record of the window repository 230. However, in other embodiments, it should be appreciated that the firm requirements 340, soft requirements, and other information may be stored in any way in the window repository 230, as long as the PR-ID 310 is associated with the appropriate information.

Specifically, the PR-ID 310, upon first being identified as a new provisioning request by the prediction system 210, is stored in the window repository 230. The PR-ID 310 is passed onto the provisioning system 125 via the provisioning system interface module 240. After the provisioning request completes or fails, which is managed by the provisioning system 125, the success or failure values are returned to the prediction system 210 as TTP 320 or TTF 330, respectively. Along with the firm requirements 340 and soft requirements 350, the information is associated with the PR-ID 310 and stored in the window repository 230.

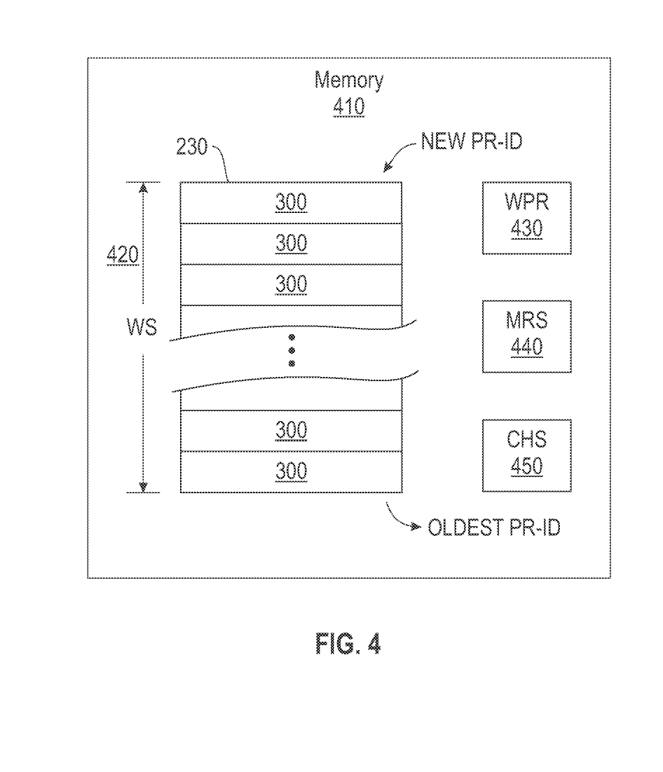

With respect to the firm requirements 340 and soft requirements 350, these requirements vary according to the resources of the computing environment 100. For example, firm requirements 340 related to a provisioning request can include, without limitation, a platform 342, a computing resource retention 344 policy or value, a computer servers amount 346, and post provisioning processes 348, such as automated installation and configuration of additional computer applications. Examples of soft requirements 350 can include, also without limitation, storage space 352, and memory size 354. When a new provisioning request is issued, the PPTA module 220 through the provisioning system 125 identifies the requirements associated with the new provisioning request. The PPTA module 220 then searches the current list of windowed PR-IDs in the window repository 230 looking for provisioning requests that are most similar to the new provisioning request. This lookup utilizes a point system and consequently a score to find the best, or if possible, exact matches, as further described below with respect to FIG. 4.

Returning to the firm requirements 340 and soft requirements 350, in one embodiment, the firm requirements 340 provide characteristics that have the greatest impact on provisioning completion time. Additionally, soft requirements 350 have less of an impact on provisioning completion time. However, these requirements can be altered dynamically. For example, in other embodiments, over time, resources can become busier or more available. Busier resources may become characterized as firm requirements 340 when formerly, they were characterized as a soft requirements 350. Moreover, by keeping a history of the time of day (e.g. business hours instead of non-business hours) and how long provisioning requests have taken to complete or fail in the past, the prediction system 210 can predict the resource provisioning time for a new provisioning request in a highly utilized computing environment 100.

By way of example, FIG. 4 illustrates an embodiment of a snapshot in time of predicting resource provisioning times in the computing environment 100. Specifically, the prediction system 210 accesses the memory 410 of the system operating the prediction system 210. As previous stated above, this system can be any computing device platform of the computing environment 100. The PPTA module 220 of the prediction system 210 reviews the window repository 230, wherein the window repository 230 is of a particular window size (WS) 420. As shown in FIG. 4, the window repository 230 includes multiple windows wherein new provisioning requests are added to the repository and the oldest PR leaves the repository. For each new provisioning request, a running group of values are updated, such as windowed provisioning request (WPR) 430 matching a window of the window repository, which is a completed provisioning request currently under examination by the PPTA module 220, a minimum required score (MRS) 440, which is the minimum provisioning request score required for the new provisioning request to be a match, and a current high score (CHS) 450, which is the current high score for a new provisioning request lookup cycle.

Before describing the scoring process to predict resource provisioning times, it is useful to describe point allocations. The PPTA module 220 is aware of point values assigned to firm requirements 340 and soft requirements 350. These values can be set by a user or administrator, and can also be changed over runtime by the prediction system 210, if resources become more or less impacted. For one embodiment, the firm requirements 340 may be allocated three points per firm requirement. Further, each soft requirement 350 may be allocated between one and three points. These points are totaled per requirement. To illustrate, if the firm requirements 340 of a particular PR-ID 310 includes a platform 342, computing resource retention 344 value, and computer servers amount 348, then the total score for the firm requirements 340 is nine points (i.e. 3+3+3). In an embodiment with only four firm requirements 340, the total point value is twelve. If the soft requirement 350 includes storage space having a point value of three and a memory size of one, the total point value is four (i.e. 3+1).

With respect to the soft requirements 350, each soft requirements resource has a default tolerance of +/−20%. This tolerance is a configurable parameter and can be altered for tuning the lookup processing. For example, if a new provisioning request is for 10 GBs of disk space of the NAS 140, then any windowed provisioning request (WPR) with disk space ranging from 8 GB to 12 GB would add 1 point to its score for satisfying the criteria. If however, the disk space for the WPR was found to be a match, then the matching PR adds three points to the score instead. The same methodology is applied to the memory resource. The highest score for the soft requirements 350 is therefore six.

Once the examination of a WPR 430 completes, the firm requirements total score and the soft requirements total score are added together and compared to the minimum required score (MRS) 440. The MRS 440 is configurable for tuning the lookup processing. Specifically, if the MRS 440 is not met, the examined WPR 430 is discounted from the lookup cycle. The next WPR 430 is examined until a match/exceed value or no match is found. The first WPR 430 of the window repository 230 to meet or exceed the MRS 440 establishes the current high score (CHS) 450. If the WPR 430 match is successful, the completion time will be included in the running TTP time and count totals for computing the average TTP for the lookup cycle for the new provisioning request.

However, if the WPR 430 is a failure, the completion time will be included in the running time and count totals for computing the average TTF. For subsequent WPRs, if the new provisioning request score meets or exceeds the MRS 440, then the score is compared to the CHS 450. If the MRS 440 is equivalent to the CHS 450, the TTP or TTF is added to the running TTP or TTF time, respectively, and count totals for the CHS 450. If the MRS 440 exceeds the CHS 450, then the MRS 440 becomes the new CHS and starts new corresponding TTP or TTF time and count totals. If the WPR 430 score is less than the CHS 450, it is discounted from the lookup cycle.

Once all WPRs have been examined for the new provisioning lookup cycle, the CHS 450 TTP and TTF averages are assigned to the new provisioning request. This formula is (TTP)/(respective count) or (TTF)/(respective count), for success or failure, respectively. Also, the respective counts are used to calculate the probability of success percentage value. This formula is (success count*100)/(success count+failure count). When the new provisioning request completes, it then replaces the oldest WPR 430, thus keeping the WPR current. It should be appreciated that if no WPR meets the MRS 440, then the average TTP and TTF of all windowed provisioning requests are assigned to the new provisioning request. This could indicate to the user, administrator, or prediction system 210 that the MRS 450 may need to be re-configured to a lower value. For example, if this condition continues for five consecutive lookup cycles, then the MRS 450 can be dynamically adjusted downward by 20% by the prediction system 210.

Over time, the window repository 230, regardless of window size, may become saturated with only successful PRs or failed PRs. If the former occurs, then the TTF cannot be calculated and the probability of a successful provisioning request would be 100%. If the latter occurs, then the TTP cannot be calculated and probability of success would be 0%.

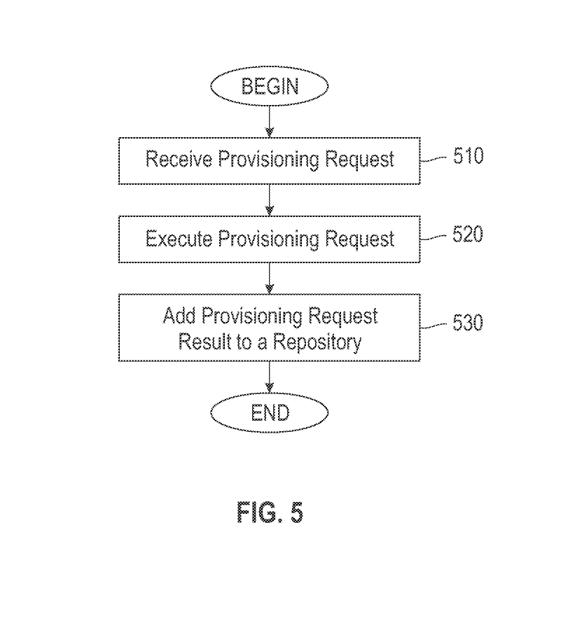

FIG. 5 illustrates an embodiment of operations for collecting a history of resource provisioning behavior. Specifically, the operations for collecting the history can be performed dynamically, during the runtime of the computing environment or can be seeded with knowledge by a user, administrator, or process of a computing system. For example, in one embodiment, an administrator may populate a window repository with PR characteristics such as the TTP, TTF, firm requirements and soft requirements for provisioning SAN storage arrays, a database system, or the like of the computing environment. In yet another embodiment, the illustrative operations of FIG. 5 can populate the window repository. In particular, in operation 510, the prediction system can receive a provisioning request originating from any device of the computing environment. Thereafter, the prediction system communicates with a provisioning system to execute the provisioning request, as illustrated by operation 520. Consequently, in operation 530, the provisioning system communicates the success or failure of the provisioning request to the prediction system, which adds the provisioning request result to the repository.

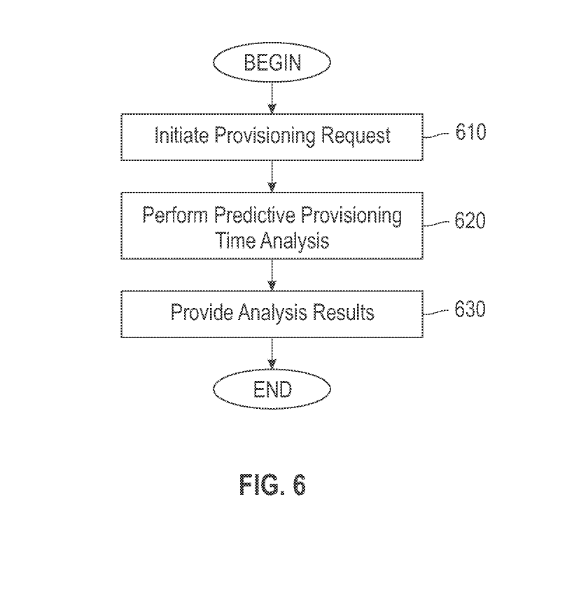

After the window repository includes at least one provisioning request result, the operations of FIG. 6 illustrate an embodiment for predicting resource provisioning times in a computing environment. Specifically, after a device or other module initiates a provisioning request in operation 610, the prediction system performs predictive provisioning time analysis as described by operation 620. In particular, the history remembers the past provisioning behavior along with successful or failure values. Factoring in the provisioning request firm requirements and soft requirements scores, the next step evaluates the new provisioning request by using a best fit scoring mechanism as described with respect to FIG. 4. Specifically, the scoring mechanism is used to match up the provisioning request to the window repository data to perform the best fit match analysis. Thereafter, the prediction system forecasts a time to provision or time to failure value.

The described operations may be implemented as a method, apparatus or computer program product using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, a semiconductor system, apparatus, or device, or any suitable combination thereof utilizing one or more suitable storage technologies, such as electronic, magnetic, optical, electromagnetic, infrared. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The variable “n” is used to represent a variable positive integer number of an element, such as variable number of chunk identifiers in object information, variable number of merge levels, etc. These variables associated with different elements may comprise a same or different integer value.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the Figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for resource provisioning in a computing environment, comprising a computer readable storage medium having computer readable program code embodied therein that executes to perform operations, the operations comprising:
receiving a provisioning request for resources of the computing environment;
executing the provisioning request for resources identified as having at least one of a firm requirement and a soft requirement;
adding a provisioning request result to a repository, wherein the repository includes information for predicting a provisioning time to complete a future provisioning request; and
determining at least one of a time to provision value and a time to failure value to complete the future provisioning request.

2. The computer program product of claim 1, wherein the resources can identify both a firm requirement and a soft requirement.

3. The computer program product of claim 1, wherein the firm requirement includes at least one of a platform, a computing resource retention value, a number of computing devices value, and post provisioning module, the post provisioning module comprising at least one of:
automating installation of the resource; and
configuring a software application.

4. The computer program product of claim 1, wherein the soft requirement identifies at least one of a storage device allocation value and a memory size.

5. The computer program product of claim 1, wherein the repository further comprises:
accumulating window values of completed provisioning requests to predict the provisioning time to complete future provisioning requests.

6. The computer program product of claim 5, further comprises:
comparing at least one window value with a minimum required score value to determine the future use of the at least one window value to predict the provisioning time to complete future provisioning requests.

7. The computer program product of claim 6, wherein the minimum required score value dynamically adjusts in relation to a plurality of successful or failed comparisons with the at least one window value.

8. The computer program product of claim 1, wherein a successful or failed future provisioning request affects the next determining of at least one of a time to provision value and a time to failure value to complete future provisioning requests.

9. A system for resource provisioning in a computing environment, comprising:
a processor of a computing device of the computing environment; and
comprising a computer readable storage medium having computer readable program code embodied executed by the processor to perform operations, the operations comprising:
receiving a provisioning request for resources of the computing environment;
executing the provisioning request for resources identified as having at least one of a firm requirement and a soft requirement;
adding a provisioning request result to a repository, wherein the repository includes information for predicting a provisioning time to complete a future provisioning request; and
determining at least one of a time to provision value and a time to failure value to complete the future provisioning request.

10. The system of claim 9, wherein the repository operates in a computing system of the computing environment.

11. The system of claim 10, wherein the repository further operates in memory of the computing system.

12. The system of claim 9, wherein the firm requirement includes a platform.

13. The system of claim 9, wherein the soft requirement includes values of least one of a storage device and a memory.

14. A method for resource provisioning in a computing environment, comprising:
receiving a provisioning request for resources of the computing environment;
executing the provisioning request for resources identified as having at least one of a firm requirement and a soft requirement;
adding a provisioning request result to a repository, wherein the repository includes information for predicting a provisioning time to complete a future provisioning request; and
determining at least one of a time to provision value and a time to failure value to complete the future provisioning request.

15. The method of claim 14, wherein the resources can identify both a firm requirement and a soft requirement.

16. The method of claim 14, wherein the firm requirement includes at least one of a platform, a computing resource retention value, a number of computing devices value, and post provisioning module, the post provisioning module comprising at least one of:
automating installation of the resource; and
configuring a software application.

17. The method of claim 14, wherein the soft requirement identifies at least one of a storage device allocation value and a memory size.

18. The method of claim 14, wherein the repository further comprises:
accumulating window values of completed provisioning requests to predict the provisioning time to complete future provisioning requests.

19. The method of claim 18, further comprises:
comparing at least one window value with a minimum required score value to determine the future use of the at least one window value to predict the provisioning time to complete future provisioning requests.

20. The method of claim 19, wherein the minimum required score value dynamically adjusts in relation to a plurality of successful or failed comparisons with the at least one window value.

21. The method of claim 14, wherein a successful or failed future provisioning request affects the next determining of at least one of a time to provision value and a time to failure value to complete future provisioning requests.
